(19) United States
(12) Patent Application Publication
(10) Pub. No.: US 2008/0011199 A1
(43) Pub. Date: Jan. 17, 2008

(54) Method for the Production of Metakaolin Particles and Use Thereof

(75) Inventor: Hans-Veit Dennert, Schlusselfeld (DE)

Correspondence Address: BROWDY AND NEIMARK, P.L.L.C.;624 NINTH STREET, NW, SUITE 300, WASHINGTON, DC, 20001-5303, US

(73) Assignee: Dennert Poraver GmbH, Postbauer-Heng (DE)

(21) Appl. No.: 11/720,165

(22) PCT Filed: Mar. 1, 2005
(86) PCT No.: PCT/EP05/02122

§ 371 Date: May 24, 2007

(30) Foreign Application Priority Data
Nov. 24, 2004 (DE) 10 2004 056 781.6

(51) Int. Cl. C04B 14/10; C04B 20/06

(52) U.S. Cl. 106/486

(57) ABSTRACT

A method for the production of metakaolin particles includes following method steps: preparing a lightweight expandable aggregate material in granulate form adding kaolin particles to the lightweight aggregate as a separating agent; feeding the separating agent-granulate mixture through a kiln; exposing the separating agent-granulate mixture to thermal energy, in order to expand the lightweight aggregate material, with simultaneous calcination of the kaolin particles into metakaolin particles; and separating the metakaolin particles from the lightweight aggregate granulate.

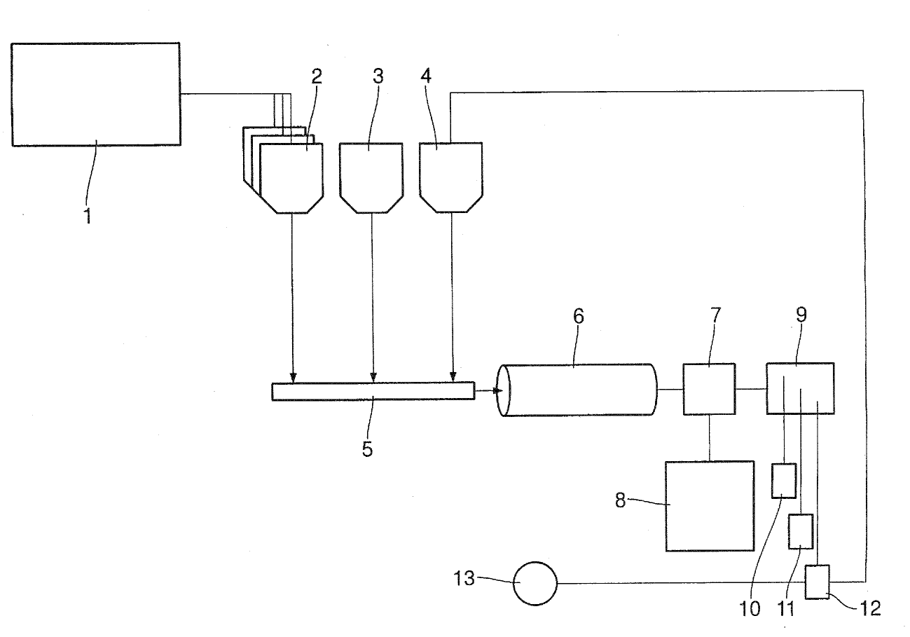

### FIELD OF THE INVENTION

The invention concerns a method for the production of metakaolin particles as well as their use as aggregate in building material composites and, in particular, tiling adhesive composites.

### BACKGROUND OF THE INVENTION

It should be noted, as a background for the invention, that chemically, metakaolin is calcinated kaolin. The main component of kaolin is the clay material kaolinite, which is a hydrated aluminium disilicate. In the production of metakaolin, kaolin is conventionally dehydrolized for a certain period, at temperatures between 500° C. and 800° C.

It is further noted here that metakaolin particles are used as aggregate in building material composites, such as for example, tiling adhesive composites. The foregoing facts are known from DE 103 15 865 B3, which deals with a combination of composites, containing a hydraulic binding agent and which is used as a tiling adhesive. The latter contains a metakaolin component with a particle size between 0.01 μm and 50 μm.

Usually, metakaolin is made in its own production process, which, by its nature is expensive for businesses, both with regard to its plant technology and considerations of resource conservation, both economic and ecological.

### SUMMARY OF THE INVENTION

To solve these problems, the invention provides a method for the production of metakaolin particles comprising the following method steps: preparing a lightweight expandable aggregate material in granulate form;
adding kaolin particles to the lightweight aggregate as a separating agent;
feeding the separating agent-granulate mixture into a kiln;
exposing the separating agent-granulate mixture to thermal energy, in order to expand the lightweight aggregate material, with simultaneous calcination of the kaolin particles into metakaolin particles; and
separating the metakaolin particles from the lightweight aggregate granulate.

This method sets up on the production of expandable lightweight aggregates, and in particular, of expanded glass granulates. In that process, for the expansion of the dried green bodies, a separating agent has to be added that will prevent the agglomeration of the expanded glass-granulate particles. Within the development of the invention, it was found out that if kaolin particles are used as the separating agent, through the thermal exposure of the separating agent-granulate mixture during the expansion of the lightweight aggregate-material, a calcination of the kaolin particles results, and metakaolin particles are created quasi as a side effect. These can be separated out and, as products of this independent process, they can be put to further uses. It is clear that no separate manufacturing process is necessary; rather, the metakaolin particles are generated as a waste product, without any separate energy costs for the calcination of the initial kaolin. Insofar within the method of the invention, the metakaolin is used for a further function, namely, as a separating agent, its utilization is indeed very efficient. The metakaolin particles created through the use of kaolin as the separating agent for the expansion of the expanded glass granulate can also be used as aggregate material in building material composites, in particular, as so-called nanoparticles in tiling adhesive composites.

Preferred embodiments of the production method according to the invention; their characteristics, details and advantages are explained in the following description, using the attached diagram.

### BRIEF DESCRIPTION OF THE DRAWING

The accompanying figure shows the flow chart for the production method.

### DESCRIPTION OF THE PREFERRED EMBODIMENT

The production method for metakaolin particles sets up on the otherwise conventional production of expandable granulate, by means of which expandable green granules (in granulate form) are made. This process, which is symbolized in the diagram by the method block 1, proceeds in the usual way, by wet-milling of recycled glass to a fine glass powder, mixing this powder with a binding agent and an expandable component, mixing and granulating these raw materials and drying the resulting granulate bodies. The last two steps can be carried out separately, by the use of a granulation dish and a subsequent drying step, or they can be combined by the use of a spray tower. The dried green granules are classified by grain-size into categories and stored in the first silo 2. Similarly, in a silo 3, new kaolin particles are stored; in silo 4, the metakaolin particles produced by a method not yet explained, are stored after being recycled there.

The new kaolin particles consist of elutriated kaolin with a median particle size of 3.0 μm; 98 mass % of it exhibits a grain size of less than 20 μm. 40 mass % of the particles are of a magnitude under 2 μm. Chemical analysis shows that the new kaolin particles consist to 50 mass % of silicium oxide and 36 mass % of aluminium oxide.

In principle, in the production process for metakaolin particles, only the new kaolin particles from silo 3 and the green granules from silo 2 can be used; these two components are mixed in a vibration chute 5 and fed continuously into a rotary kiln 6, where, at temperatures between 800° C. and 900° C., the expansion process of the green granules into actual expanded glass granulate takes place, while at the same time, the calcination of the new kaolin particles, which serve as the separating agent, is turning them into metakaolin particles. The output products of the rotary kiln 6 are transported through a fluidized bed cooler 7, where, by means of air stream movement, a separation takes place: the expanded glass particles with a grain size of over 300 μm, on the one hand, are separated from the remaining portion, on the other hand, which consists of expanded glass granulate particles with a grain size of under 300 μm and the metakaolin particles that exhibit a grain size of under 50 μm. The former expanded glass granulate is conveyed to block 8, which symbolizes further processing, namely, classifying, storing, packaging in bags—so-called “big bags”—or transport in silo vehicles. The remaining portion is fed through a two-stage wind sorting process 9, the separation limits being set at 50 μm and 110 μm, respectively, so that three groups are now created, namely, expanded glass granulate of two grain sizes, approximately 100 μm to 300 μm, which is conveved into block 10, and of approximately 40 μm to 100 μm, which go into block 11, as well as the metakaolin particles, their grain size essentially below 50 μm, which are destined for block 12. The latter can be regarded as a product at this stage and conveyed elsewhere, except that, for economic reasons, they can be reused several times as the separating agent in the production of expanded glass granulate, and thus, they are moved from block 12 back into the storage silo 4.

Chemical analysis of the metakaolin particles thus produced has shown that alkali oxide particles from the expanded glass granulate tend to accumulate within them. A component of 12 mass % alkali oxide has been determined to the upper limit of the metakaolin particles being reused. When this proportion is reached, the metakaolin is considered to be used up, as regards its function as a separating agent, and it can be sluiced off—block 13—as being a metakaolin particle product that can be used in other ways.

The proportion of the supplemental new kaolin particles to metakaolin partides within the separation agent in the rotary kiln 6 depends on the grain size of the granulate to be expanded. For large grain sizes of the expandable glass granulate, i.e., 4 to 8 mm and 8 to 16 mm, only returned metakaolin particles are added to the separating agent, namely in a proportion of 12% to 15% of the total separation agent-granulate mixture. The finer the grain of the granulate to be expanded, the larger the proportion of separation agent as a whole, and of new kaolin particles in the separation agent. Thus, for an expanded-glass granulate-grain size of 0.1 mm to 0.3 mm, about 25% to 30% of kaolin separation agent will be required in the entire separation agent-granulate mixture, which represents a proportion of new kaolin particles to metakaolin particles ranging between 30:70 and 40:60.

The metakaolin particles with a grain size of under 50 μm, which are supplied by the production method discussed, can be used in combination with the expanded glass granulate particles that were classified by wind sorting in steps 10 and 11, i.e., those with grain sizes of 40 μm to 125 μm and 100 μm to 300 μm, as pre-fabricated aggregate mixtures for building material composites, such as tiling adhesive composites, as described by DE 103 15 865 B3, as was mentioned at the beginning.

What is claimed is:

1. A method for the production of metakaolin particles comprising the following method steps:
preparing a lightweight expandable aggregate material in granulate form;
adding kaolin particles to the lightweight aggregate as a separating agent;
feeding the separating agent-granulate mixture through a kiln;
exposing the separating agent-granulate mixture to thermal energy, in order to expand the lightweight aggregate material, with simultaneous calcination of the kaolin particles into metakaolin particles; and
separating the metakaolin particles from the lightweight aggregate granulate.

2. Method according to claim 1, wherein the kaolin particles added consist of new kaolin particles and/or returned metakaolin particles.

3. Method according to claim 2, wherein the proportion of new kaolin partides in the total amount of the separation agent is anywhere up to 40%.

4. Method according to claim 2, wherein the separated metakaolin particles are not returned any longer, once their alkali oxide content has reached 12 mass %.

5. Method according to claim 2, wherein the new kaolin particles exhibit a high proportional content of aluminium oxide, preferably as high as 35 mass %.

6. Method according to claim 1, wherein the proportionate amount of kaolin particles in the total separating agent-granulate mixture is dependent on the grain size of the lightweight aggregate granulate and varying between 12% and 30%.

7. Method according to claim 1, wherein the separation agent-granulate mixture is exposed to thermal energy at a temperature of 800° C. to 900° C. preferably being delivered in a continuously operating rotary furnace.

8. Method according to claim 1, wherein the metakaolin particles are separated in two stages.

9. Method according to claim 8, wherein the metakaolin particles are separated by air stream movement in a fluid bed cooler and by wind sorting.

10. Method according to claim 8, wherein the separated metakaolin particles exhibit a grain size below about 50 μm.

11. Use of the kaolin, which is employed as a separating agent in the process of expanding the lightweight aggregate material granulate and which, by thermal exposure according to claim 1, has been calcinated into metakaolin particles, as an aggregate material in building material composites, in particular, tiling adhesive composites.

12. Use according to claim 11, wherein the lightweight aggregate particles, which are produced in the same process with the metakaolin particles, are employed as pre-fabricated aggregate mixtures in building material composites, in particular, tiling adhesive composites.
